(19) United States
(12) Patent Application Publication
(10) Pub. No.: US 2022/0391060 A1
(43) Pub. Date: Dec. 8, 2022

(54) METHODS FOR DISPLAYING AND PROVIDING MULTIMEDIA RESOURCES

(71) Applicant: Jinze HAN, Beijing (CN)

(72) Inventor: Jinze HAN, Beijing (CN)

(21) Appl. No.: 17/889,830

(22) Filed: Aug. 17, 2022

Related U.S. Application Data
(63) Continuation of application No. PCT/CN2021/076252, filed on Feb. 9, 2021.

(30) Foreign Application Priority Data
Feb. 19, 2020 (CN) 202010101761.1

(51) Int. Cl. G06F 3/0484; G06F 40/279; G06F 3/0481; H04L 9/40

(52) U.S. Cl. CPC G06F 3/0484; G06F 40/279; G06F 3/0481; H04L 63/102

(57) ABSTRACT

Provided is a method for displaying multimedia resources. The method is applicable to a terminal, and includes: receiving an interaction operation performed by a target user account on a target multimedia resource; and displaying an associated multimedia resource of the target multimedia resource in response to the interaction operation satisfying a predetermined interaction operation type.

This application is a continuation of PCT Application No. PCT/CN2021/076252, filed Feb. 9, 2021, which claims priority to Chinese Patent Application No. CN202010101761.1, filed on Feb. 19, 2020, the disclosures of which are herein incorporated by reference in their entirety.

### TECHNICAL FIELD

The present disclosure relates to the field of Internet computer technologies, and in particular, relates to methods for displaying and providing multimedia resources.

### BACKGROUND

With the advancement of network technologies, more and more platforms are developed for posting self-made multimedia resources. This provides numerous opportunities for users to exhibit their creative wills.

An author posts his or her self-made multimedia resources based on a multimedia resource platform, and other users browse the multimedia resources over the multimedia resource platform or a platform client and give their viewpoints regarding the posted multimedia resources by, for example, giving likes, giving comments or the like interactions to promote the poster to create and post more excellent and quality works.

### SUMMARY

Embodiments of the present disclosure provide methods for displaying and providing multimedia resources. Technical solutions of the present disclosure are as follows.

According to one aspect of the embodiments of the present disclosure, a method for displaying multimedia resources is provided. The method is applicable to a terminal, and includes: receiving an interaction operation performed by a target user account on a target multimedia resource; and displaying an associated multimedia resource of the target multimedia resource in response to the interaction operation satisfying a predetermined interaction operation type.

According to another aspect of the embodiments of the present disclosure, a method for providing multimedia resources is provided. The method is applicable to a server, and includes: receiving an interaction operation performed by a target user account on a target multimedia resource; and providing an associated multimedia resource of the target multimedia resource to the target user account in response to the interaction operation satisfying a predetermined interaction operation type.

According to still another aspect of the embodiments of the present disclosure, a terminal is provided. The terminal includes: a processor; and a memory configured to store one or more instructions executable by the processor; wherein the processor, when loading and executing the one or more instructions, is caused to: receive an interaction operation performed by a target user account on a target multimedia resource; and display an associated multimedia resource of the target multimedia resource in response to the interaction operation satisfying a predetermined interaction operation type.

### BRIEF DESCRIPTION OF THE DRAWINGS

FIG. 1 is a flowchart of a method for displaying multimedia resources according to an embodiment of the present disclosure;

FIG. 2 is a flowchart of a method for displaying multimedia resources according to an embodiment of the present disclosure;

FIG. 3 is a schematic diagram of interface jumping based on an interaction operation according to an embodiment of the present disclosure;

FIG. 4 is a schematic operation flowchart of a resource association configuration interface according to an embodiment of the present disclosure;

FIG. 5 is a flowchart of a method for providing multimedia resources according to an embodiment of the present disclosure;

FIG. 6 is a block diagram of an apparatus for displaying multimedia resources according to an embodiment of the present disclosure;

FIG. 7 is a block diagram of an apparatus for providing multimedia resources according to an embodiment of the present disclosure;

FIG. 8 is a block diagram of a terminal according to an embodiment of the present disclosure;

FIG. 9 is a block diagram of a server according to an embodiment of the present disclosure;

FIG. 10 is an architecture diagram of a system for displaying multimedia resources according to an embodiment of the present disclosure; and

FIG. 11 is an interaction flowchart of a method for displaying multimedia resources according to an embodiment of the present disclosure.

### DETAILED DESCRIPTION

It should be noted that the terms such as “first,” “second,” and the like in the specifications, claims and the accompanying drawings of the present disclosure are intended to distinguish different objects but are not intended to define a specific order or a definite time sequence. It should be understood that data used herein may be exchanged in any suitable scenario, such that the embodiments of the present disclosure described herein may be practiced in other orders in addition to that illustrated in the drawings or described herein in the text.

It should be noted that the information (which includes, but is not limited to, device information, personal information, and the like of a user), data (which includes, but is not limited to, data for analysis, data for storage, data for display, and the like) and signals involved in the present disclosure are all authorized by the user or sufficiently authorized by all parties; and in addition, acquisition, use, and processing of related data shall comply with related laws, regulations, and standards of related countries and regions. For example, commentary content and the like posted by a target user account involved in the present disclosure are all acquired under sufficient authorization.

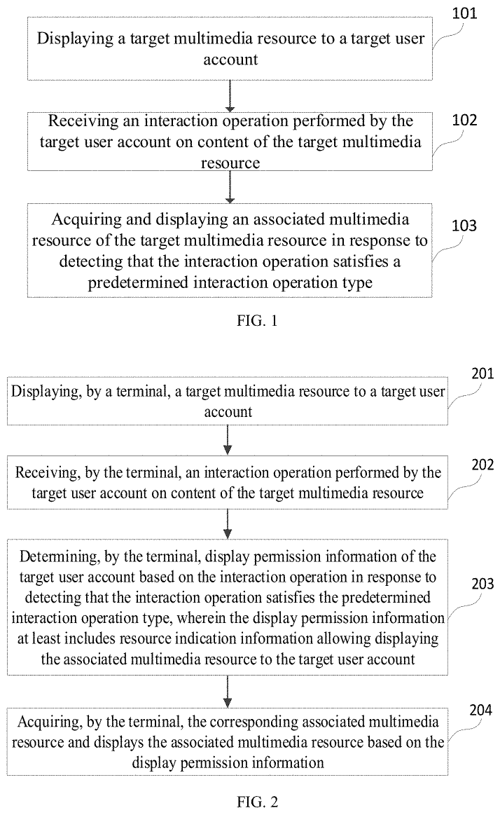

FIG. 1 is a flowchart of a method for displaying multimedia resources according to an embodiment of the present disclosure. As illustrated in FIG. 1, the method includes the following steps.

In 101, a terminal displays a target multimedia resource to a target user account.

The target user account is a user account currently logged in to the terminal. The target multimedia resource is displayed in response to a trigger on the target multimedia resource by the target user account, or displayed in response to a consecutive play relationship between multimedia resources. That is, the target multimedia resource is automatically displayed upon completion of display of a previous multimedia resource. The embodiments of the present disclosure set no specific limitation on how displaying of the target multimedia resource is triggered.

In some embodiments, a resource type of the target multimedia resource or associated multimedia resource includes: a video resource, an audio resource, a picture resource, a text resource, a webpage resource, and the like. The embodiments of the present disclosure set no specific limitation on the resource type of the multimedia resource.

In 102, the terminal receives an interaction operation performed by the target user account on content of the target multimedia resource.

102 is a possible practice for the terminal to receive the interaction operation performed by the target user account on the target multimedia resource.

In some embodiments, the terminal does not display the target multimedia resource to the target user account, but only receives an interaction operation performed by the target user account on a pattern identifier on the target multimedia resource, which is not specifically limited in the embodiments of the present disclosure.

In the embodiments of the present disclosure, the interaction operation on the content of the target multimedia resource refers to an interaction operation for indicating whether a user viewing the resource is interested in the content of the multimedia resource. For example, a like operation is an operation for giving a like on the content of the multimedia resource, and a dislike operation is an operation for giving a dislike on the content of the multimedia resource.

In some embodiments, giving a positive comment on a comment page of the multimedia resource is also an operation for giving a like on the content of the multimedia resource, and giving a negative comment on the comment page of the multimedia resource is also an operation for giving a dislike on the content of the multimedia resource. For details about other operations on the content, an analogous deduction may be made with reference to the above examples, which are not described herein any further.

In 103, the terminal acquires and displays an associated multimedia resource of the target multimedia resource in response to detecting that the interaction operation satisfies a predetermined interaction operation type.

103 is a possible practice for the terminal to display the associated multimedia resource of the target multimedia resource in response to the interaction operation satisfying the predetermined interaction operation type.

In some embodiments, the predetermined interaction operation type is predefined by a poster of the target multimedia resource, such that a user viewing the resource triggers an interaction operation while viewing the target multimedia resource to acquire an associated multimedia resource predefined by the poster, thereby achieving content-based interaction.

In some embodiments, the predetermined interaction operation type at least includes one of: a like operation, a share operation, a comment operation, an add-to-favorites operation, or a virtual item present operation; and acquiring and displaying the associated multimedia resource in response to detecting that the interaction operation satisfies the predetermined interaction operation type includes: determining display permission information of the target user account based on the interaction operation in response to detecting that the interaction operation satisfies the predetermined interaction operation type, wherein the display permission information at least includes resource indication information of the associated multimedia resource allowed to be displayed to the target user account; and acquiring and displaying the associated multimedia resource based on the display permission information. That is, the display permission information of the target user account is determined based on the interaction operation in the case that the interaction operation satisfies the predetermined interaction operation type, and the associated multimedia resource indicated by the resource indication information in the display permission information is displayed based on the display permission information.

In some embodiments, the resource indication information is indicative of a plurality of associated multimedia resources, and the display permission information further includes a display order of the plurality of associated multimedia resources; and acquiring and displaying the corresponding associated multimedia resource based on the display permission information includes: acquiring the plurality of associated multimedia resources indicated by the resource indication information based on the resource indication information; and successively displaying the plurality of associated multimedia resources based on the display order.

In some embodiments, the predetermined interaction operation type includes a comment operation for posting predetermined commentary content; and the method further includes: acquiring, in response to detecting that the interaction operation is the comment operation, commentary content posted by the comment operation; determining whether the commentary content is the predetermined commentary content by analyzing the commentary content; and determining, in response to the commentary content being the predetermined commentary content, that the interaction operation satisfies the predetermined interaction operation type. That is, the commentary content posted by the comment operation is acquired in the case that the interaction operation is the comment operation, and in the case that the commentary content is the predetermined commentary content, it is determined that the interaction operation satisfies the predetermined interaction operation type.

In some embodiments, the predetermined commentary content is a comment including a predetermined keyword; and determining whether the commentary content is the predetermined commentary content by analyzing the commentary content includes: acquiring a commentary word set by word segmentation on the commentary content; and determining, in response to detecting that the commentary word set includes the predetermined keyword, that the commentary content is the predetermined commentary content. That is, the commentary word set is acquired by word segmentation on the commentary content, and in the case that the commentary word set includes the predetermined keyword, it is determined that the commentary content is the predetermined commentary content.

In some embodiments, the predetermined commentary content is positive commentary content; and determining whether the commentary content is the predetermined commentary content by analyzing the commentary content includes: identifying the commentary content using a pre-trained comment identification model, and determining whether the commentary content is positive commentary content, wherein the comment identification model is acquired by training using a predetermined machine learning algorithm based on an acquired comment sample and a predetermined positive comment verification sample, and is configured to identify input commentary content and output an identification result indicating whether the commentary content is positive commentary content. That is, the commentary content is identified using the comment identification model, and whether the commentary content is the positive commentary content is determined.

In some embodiments, the associated multimedia resource at least includes one of: other work segments of a work to which the target multimedia resource belongs, a sequel to the target multimedia resource, behind-the-scenes clips of the target multimedia resource, a customized work provided by a poster of the target multimedia resource, and a latest work of the poster of the target multimedia resource.

In some embodiments, acquiring and displaying the associated multimedia resource of the target multimedia resource includes: displaying prompt information, wherein the prompt information is defined to prompt a user to issue an instruction to display the associated multimedia resource through jumping; and acquiring and displaying the associated multimedia resource of the target multimedia resource in response to the instruction. That is, the prompt information is displayed, wherein the prompt information is defined to prompt the user to issue the instruction to display the associated multimedia resource through jumping, and the associated multimedia resource of the target multimedia resource is displayed in response to the instruction.

In some embodiments, the method further includes: associating, in response to a resource associate operation performed by the target user account on a resource association configuration interface, a first multimedia resource with a second multimedia resource that are provided by the target user account, such that in the case that the first multimedia resource is displayed, the second multimedia resource is displayed in response to an interaction operation of another user account satisfying the predetermined interaction operation type. That is, the first multimedia resource and the second multimedia resource that are provided by the target user account are associated in response to the resource associate operation performed by the target user account on a resource association configuration interface, such that in the case that the first multimedia resource is displayed, the second multimedia resource is displayed in response to the interaction operation of another user account satisfying the predetermined interaction operation type.

In some embodiments, associating the first multimedia resource with the second multimedia resource provided by the target user account includes: associating the first multimedia resource with different second multimedia resources with respect to different predetermined interaction operation types.

In some embodiments, associating the first multimedia resource with the second multimedia resource provided by the target user account includes: generating, based on a display order of the first multimedia resource and a plurality of second multimedia resources, display permission information including the display order, wherein the display permission information at least includes resource indication information of the associated multimedia resource allowed to be displayed, so as to establish an association between the first multimedia resource and the second multimedia resource.

In some embodiments, the method further includes: acquiring partitioning information with respect to the multimedia resource, and partitioning the multimedia resources into the first multimedia resource and the second multimedia resource based on the partitioning information.

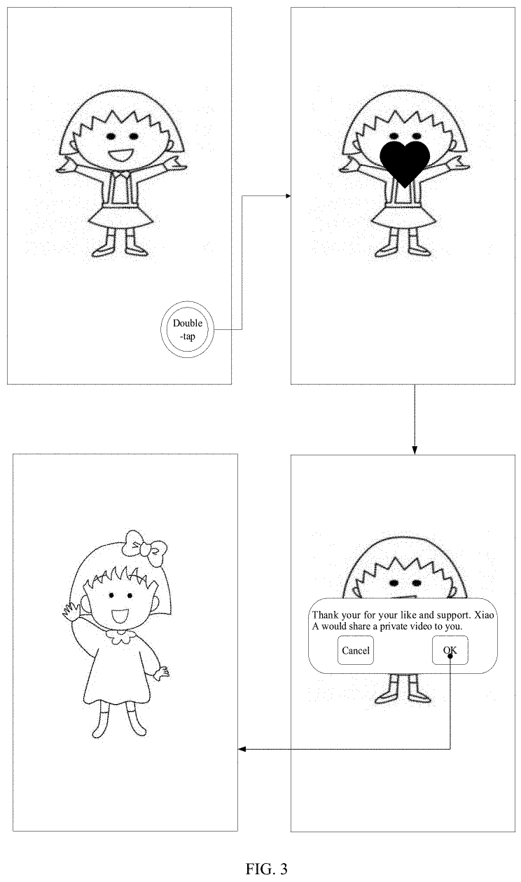

FIG. 2 is a flowchart of a method for displaying multimedia resources according to an embodiment of the present disclosure. As illustrated in FIG. 2, the method for displaying multimedia resources is implemented based on interactions between a terminal and a server, and includes the following steps.

In 201, the terminal displays a target multimedia resource to a target user account.

Displaying, by the terminal, the target multimedia resource to the target user account includes: playing, by the terminal, the target multimedia resource in the case that the target user account is logged in to the terminal.

In some embodiments, at least one control is provided on a playing interface of the target multimedia resource, wherein the control may be triggered in response to a trigger operation of a user to perform the interaction operation supported by the control.

In 202, the terminal receives an interaction operation performed by the target user account on content of the target multimedia resource.

202 is a possible practice for the terminal to receive the interaction operation performed by the target user account on the target multimedia resource.

In some embodiments, the terminal does not display the target multimedia resource to the target user account, but only receives an interaction operation performed by the target user account on a pattern identifier of the target multimedia resource, which is not specifically limited in the embodiments of the present disclosure.

In some embodiments, the interaction operation in 202 is performed based on an interaction operation option or a specific gesture on a resource interface, which is not limited in the embodiments of the present disclosure. For example, the specific gesture is provided on a screen of the target multimedia resource to perform the interaction operation. For example, in response to detecting a double-tap operation, the terminal determines that a like operation on the content of the target multimedia resource is received.

In some embodiments, the terminal independently provides an interaction function based on the interaction operation option or an interaction function based on the specific gesture, or the terminal simultaneously provides these two interaction functions, such that more flexible choices for triggering the interaction operation are provided and thus a man-machine interaction efficiency of triggering the interaction operation is improved, which is not limited in the embodiments of the present disclosure.

In 203, the terminal determines display permission information of the target user account based on the interaction operation in response to detecting that the interaction operation satisfies the predetermined interaction operation type, wherein the display permission information at least includes resource indication information of the associated multimedia resource allowed to be displayed to the target user account.

203 is a possible practice for the terminal to determine the display permission information of the target user account based on the interaction operation in response to the interaction operation satisfying the predetermined interaction operation type.

In the embodiments of the present disclosure, the predetermined interaction operation type at least includes one of: a like operation, a share operation, a comment operation, an add-to-favorites operation, or a virtual item present operation; and the terminal detects received interaction operation based on a predetermined interaction operation type predefined by the author (poster) of the target multimedia resource or defaulted in the system, and performs the process of determining the display permission information in 203 in response to determining that an interaction operation type of the received interaction operation satisfies the predetermined interaction operation type.

It should be noted that the predetermined interaction operation type at least including one of the like operation, the share operation, the comment operation, the add-to-favorites operation, or the virtual item present operation means that the predetermined interaction operation type includes any one of the like operation, the share operation, the comment operation, the add-to-favorites operation, or the virtual item present operation, or the predetermined interaction operation type includes a combination of at least two of the like operation, the share operation, the comment operation, the add-to-favorites operation, or the virtual item present operation, which is not limited in the embodiments of the present disclosure.

The display permission information is permission information defined to limit whether a user account has a permission to further view multimedia resources and which type of multimedia resources the user can view. In some embodiments, different display permission information may be defined with respect to different interaction operation types. For example, with respect to a like operation, display permission information of a video A is acquired, wherein the video A includes video content for thanking the like operation of a user viewing the resource, and then an operation of acquiring and displaying the video A is performed in 204. Still for example, with respect to a share operation, display permission information of a video B is acquired, wherein the video B includes video content for thanking a share operation of a user viewing the resource, and then an operation of acquiring and displaying the video B is performed in 204.

In 204, the terminal acquires and displays the corresponding associated multimedia resource based on the display permission information.

204 is a possible practice for the terminal to display, based on the display permission information, the associated multimedia resource indicated by the resource indication information in the display permission information.

In some embodiments, acquiring and displaying, by the terminal, the corresponding associated multimedia resource based on the display permission information includes: acquiring, by the terminal, based on the display permission information, the resource indication information of the associated multimedia resource corresponding to the display permission information of the target multimedia resource, and downloading and displaying, by the terminal, the associated multimedia resource based on the resource indication information.

In some embodiments, the resource indication information is a resource identifier, and identifies the multimedia resource. For example, the resource indication information is a resource serial number or the like information. The terminal queries, based on the resource identifier, resource address information of the associated multimedia resource, and further downloads and displays the associated multimedia resource based on the resource address information. In some embodiments, the resource indication information is resource address information, and is representative of a network storage address of the multimedia resource. For example, the resource indication information is a uniform resource locator (URL), such that the terminal is capable of directly downloading and displaying the associated multimedia resource based on the resource address information.

In some embodiments, in the process of acquiring the resource indication information, the terminal sends an indication information acquisition instruction to the server in response to the interaction operation satisfying the predetermined interaction operation type, and receives the resource indication information returned, in response to the indication information acquisition instruction, by the server. In this case, the resource indication information is acquired only when the type of the interaction operation is determined, such that waste of resources is prevented to some extent.

In some embodiments, in the process of acquiring the resource indication information, the terminal acquires the resource indication information corresponding to the display permission information from pre-stored resource indication information of the associated multimedia resource of the target multimedia resource. That is, the resource indication information is acquired in advance. In this way, time elapsed for acquiring the resource indication information is reduced, and a display efficiency is improved.

In some embodiments, in the process of acquiring the resource indication information in advance, the terminal acquires the resource indication information from a playing data stream of the target multimedia resource. That is, the server carries the resource indication information in the playing data stream of the target multimedia resource, such that the terminal is capable of acquiring the resource indication information in displaying the multimedia resource, thereby saving interaction signaling.

In some embodiments, in the process of acquiring the resource indication information in advance, the terminal independently downloads the resource indication information from the server. That is, the terminal acquires, at any moment the target multimedia resource is displayed, for example, a playing start moment, any moment during playing, a playing end moment, or the like, the resource indication information from the server providing the target multimedia resource. In some embodiments, the terminal automatically sends an indication information acquisition instruction to the server in response to a display progress of the target multimedia resource being greater than a target progress, so as to receive the resource indication information returned by the server in response to the indication information acquisition instruction. In this way, in the case that the user shifts to a next multimedia resource before a viewing progress reaches the target progress, the terminal does not need to request the resource indication information from the server, such that interaction signaling is saved.

In some embodiments, one piece of display permission information is indicative of a plurality of associated multimedia resources which are allowed to be displayed to the target user account. For example, the resource indication information is indicative of the plurality of associated multimedia resources. The display permission information further includes a display order of the plurality of associated multimedia resources. That is, acquiring and displaying the associated multimedia resource include: acquiring, by the terminal, based on the resource indication information, the plurality of associated multimedia resources indicated by the resource indication information; and successively displaying the plurality of associated multimedia resources based on the display order. By successively displaying the plurality of associated multimedia resources based on the display order, multi-interaction is achieved without manual trigger by the user, and successive display of the plurality of associated multimedia resources is triggered by one interaction operation, thereby improving the man-machine interaction efficiency.

In the above process, the terminal downloads the plurality of associated multimedia resources from the server based on the resource indication information. In some embodiments, the terminal downloads all of the plurality of associated multimedia resources from the server; or during or upon display of an associated multimedia resource, downloads an associated multimedia resource following the associated multimedia resource being displayed, which is not limited in the embodiments of the present disclosure.

203 and 204 describe the process of displaying, by the terminal, the associated multimedia resource of the target multimedia resource in response to the interaction operation satisfying the predetermined interaction operation type, determining the display permission information based on different interaction operation types, and displaying different multimedia resources to the user account. In this way, targeted feedback is given with respect to the actual interaction, such that the man-machine interaction efficiency is improved. Furthermore, the display permission information is further defined to allow displaying one or more associated multimedia resources to the target user account. In the case that the plurality of associated multimedia resources are allowed to be displayed, the associated multimedia resources are displayed in a predetermined display order, such that the man-machine interaction efficiency is further improved.

In some embodiments, in the case that the interaction operation is the comment operation, whether the interaction operation is of the predetermined interaction operation type is determined based on the commentary content posted by the target user account. In some embodiments, the predetermined interaction operation type includes a comment operation for posting predetermined commentary content; and the method further includes: acquiring, in response to detecting that the interaction operation is the comment operation, commentary content posted by the comment operation; determining whether the commentary content is the predetermined commentary content by analyzing the commentary content; and determining, in response to the commentary content being the predetermined commentary content, that the interaction operation satisfies the predetermined interaction operation type.

That is, the commentary content posted by the comment operation is acquired in the case that the interaction operation is the comment operation; and in the case that the commentary content is the predetermined commentary content, it is determined that the interaction operation satisfies the predetermined interaction operation type. In some embodiments, the commentary content posted by the comment operation is a bullet comment, or a leaved comment, a work comment, or the like posted to an interaction and living comment region, which is not limited in the embodiments of the present disclosure.

In some embodiments, in the process of determining whether the commentary content is the predetermined commentary content by analyzing the commentary content, different analysis methods are employed depending on different predetermined commentary content.

In some embodiments, the predetermined commentary content is a comment including a predetermined keyword; and the above analysis process includes: acquiring a commentary word set by word segmentation on the commentary content; and determining, in response to detecting that the commentary word set includes the predetermined keyword, that the commentary content is the predetermined commentary content.

In some embodiments, the predetermined keyword is predefined by the poster or defaulted in the system. Once posted commentary content includes the predetermined keyword, it is determined that the posted commentary content is the predetermined commentary content. For example, the predetermined keyword is a word such as “excellent,” “like,” “finger heart,” or the like for expressing recognition and appreciation. On this basis, whether the interaction operation type satisfies the predetermined interaction operation type is determined by keyword matching, and thus the associated multimedia resource is displayed with respect to specified commentary content, such that display of the associated multimedia resource is of pertinence. In addition, because a calculation amount of keyword matching is small, the processing is quickened, such that the interaction operation is quickly responded to and the resource is quickly displayed.

In some embodiments, the predetermined commentary content is the positive commentary content; and the above analysis process includes: identifying the commentary content using a pre-trained comment identification model, and determining whether the commentary content is the positive commentary content, wherein the comment identification model is acquired by training using a predetermined machine learning algorithm based on an acquired comment sample and a predetermined positive comment verification sample, and is configured to identify input commentary content and output an identification result indicating whether the commentary content is the positive commentary content. Whether the commentary content is the positive commentary content is determined using the comment identification model acquired based on the machine learning algorithm, and hence the associated multimedia resource is displayed only with respect to commentary content having a specific tendency. The displaying is of pertinence, such that the identification result is more accurate. That is, the commentary content is identified using the comment identification model; and whether the commentary content is the positive commentary content is determined. In some embodiments, the comment identification model is implemented by a binary classification model, a decision tree model, or the like, which is not specifically limited in the present disclosure.

In some embodiments, the terminal does not directly display the associated multimedia resource, but first prompts the poster that the associated multimedia resource is further provided, such that whether to display the associated multimedia resource is determined based on the actual operation of the target user account. That is, acquiring and displaying the associated multimedia resource of the target multimedia resource include: displaying prompt information, wherein the prompt information is defined to prompt a user to issue an instruction to display the associated multimedia resource through jumping; and acquiring and displaying the associated multimedia resource of the target multimedia resource in response to the instruction, that is, displaying the associated multimedia resource of the target multimedia resource in response to the instruction. That is, the associated multimedia resource is acquired in the case that target user account desires to play the associated multimedia resource, such that waste of traffic is prevented.

The terminal displays prompt information upon acquiring the resource indication information. In some embodiments, a display layout of the prompt information and a display layout of a control in the prompt information are both defaulted in the system or adjusted according to the actual needs of the poster. The text portion of the prompt information is predefined by the poster. In some embodiments, a variable portion is provided in the text portion of the prompt information, such that the user alters the variable portion in response to initiation of the interaction operation. For example, the text portion of the prompt information includes an account name of the target user account, so as to improve the interaction efficiency.

In some embodiments, the poster customizes by himself or herself a window template to exhibit individuality. The control includes a first control configured to determine to execute jumping, and a second control configured to cancel popup display, such that a convenient interface for the user to cancel or jump the popup display is provided, and the operation convenience and the man-machine interaction efficiency are improved. In the case that the user viewing the resource does not want to continue viewing the associated multimedia resource, the user cancels popup information by triggering the second control, and performs a subsequent operation at his or her will, which is not limited in the embodiments of the present disclosure.

In some embodiments, description is given by taking the associated multimedia resource being an associated video as an example. Referring to an upper left part in FIG. 3, the user performs a double-tap operation on a video playing interface. In response to detecting the double-tap operation, the terminal displays an animation effect of successfully giving a like, as illustrated in an upper right part in FIG. 3. By interaction between the terminal and the server, the terminal acquires an address of the associated video of a video being played, and displays prompt information based on the acquired address. As illustrated in a lower right part in FIG. 3, the prompt information includes prompt texts, and further includes an account name of a poster, an OK control configured to determine to execute jumping, and a Cancel control configured to cancel popup display. In response to detecting a trigger operation on the OK control, the terminal acquires and displays the associated video, and then jumps to the video playing interface as illustrated in a lower left part in FIG. 3.

It should be noted that with respect to an effected interaction operation, a cancel function is also provided. That is, the user may cancel, by interaction operation cancellation, an interaction operation that has been performed. In this case, in response to detecting that a newly triggered interaction operation satisfies the predetermined interaction operation type in the case that the user cancels the interaction operation, the terminal is still capable of displaying the associated multimedia resource in accordance with the above procedure. For example, taking a like operation as an example, the user cancels the like that has been given, and in this case, where the user performs a like operation again, the terminal displays again the associated multimedia resource.

In the embodiments of the present disclosure, the associated multimedia resource at least includes one of:

other work segments of a work to which the target multimedia resource belongs, wherein different segments of the work are provided by means of segments, such that a smooth viewing fashion of a complete work is provided to the target user account, and viewing smoothness of different segments of the same work is improved;

a sequel to the target multimedia resource, wherein by sequel association, multimedia resources are predictively displayed based on the actual playing behaviors of the target user account, such that viewing smoothness of a plurality of associated works is provided;

behind-the-scenes clips of the target multimedia resource, wherein by behind-the-scenes clip association, deep interaction between the user account and the current target multimedia resource is achieved; and

a customized work provided by the poster of the target multimedia resource or a latest work provided by the poster of the target multimedia resource, wherein by customized work association, a targeted interaction is provided to the target user account, and by latest work association, other works of the poster may be promoted and advertised, such that an exposure rate of the other works is improved.

It should be noted that the associated multimedia resource including at least one of the above various types of resources means that: the associated multimedia resource includes any one of the other work segments of the work to which the target multimedia resource belongs, the sequel to the target multimedia resource, the behind-the-scenes clips of the target multimedia resource, the customized work provided by the poster of the target multimedia resource, or the latest work provided by the poster of the target multimedia resource; or the associated multimedia resource includes a combination of at least two of the other work segments of the work to which the target multimedia resource belongs, the sequel to the target multimedia resource, the behind-the-scenes clips of the target multimedia resource, the customized work provided by the poster of the target multimedia resource, or the latest work provided by the poster of the target multimedia resource.

The above embodiments describe how the user viewing the resource performs the interaction operation on the terminal to display the multimedia resource. With respect to the poster, the terminal provides a function of setting the associated multimedia resource, such that the poster is capable of setting the associated multimedia resource for the multimedia resource according to his or her actual needs, and the associated multimedia resource is provided to the user viewing the resource. The associated multimedia resource is set by: associating, in response to the resource associate operation performed by the target user account on a resource association configuration interface, the first multimedia resource with the second multimedia resource that are provided by the target user account, such that in the case that the first multimedia resource is displayed, the second multimedia resource is displayed in response to the interaction operation of another user account satisfying the predetermined interaction operation type.

The resource association configuration interface is an interface applied by the user to establish a multimedia resource association. The multimedia resource may be imported via the interface; or a photographing function may be triggered on this interface, such that the camera of the terminal is started for photographing to acquire the multimedia resource. For example, the resource association configuration interface is provided by a resource posting interface. That is, the associated multimedia resource is set in posting a new resource by the user.

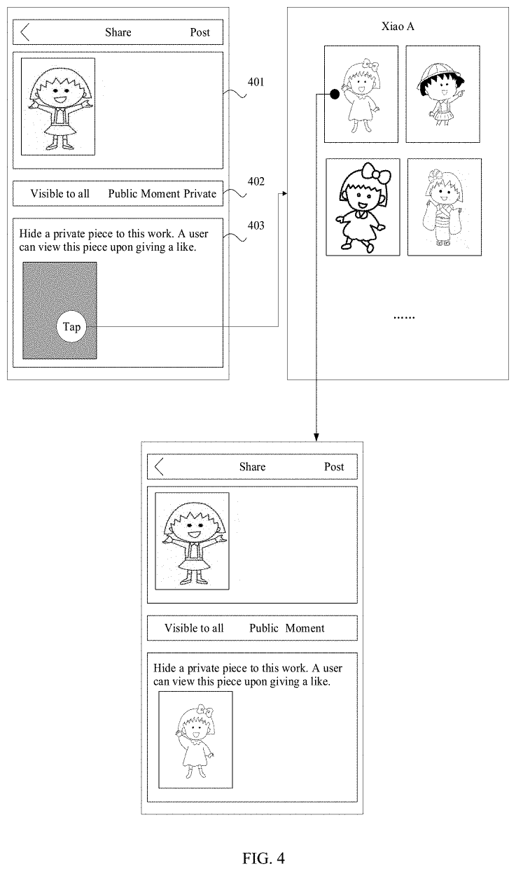

For example, description is given by taking the resource association configuration interface being provided as the resource posting interface as an example. As illustrated in an upper left part in FIG. 4, the resource posting interface includes a resource preview region 401, a visible selection region 402, and a resource jumping permission setting interface 403. Setting prompt information is provided on the resource jumping permission setting interface 403, for example, “Hide a private piece to this work, and a user can view this piece upon giving a like.” In the case that a tap operation is performed by the user on the permission setting region 402, a work selecting interface of the user illustrated in an upper right part in FIG. 4 is displayed. The work selecting interface includes a plurality of works of the user. The plurality of works include at least one of works posted by the user and works to be posted by the user. In the case that a select operation is performed by the user on at least one multimedia resource in the work selecting interface, the selected multimedia resource is displayed in the permission setting interface 403, as illustrated in a lower part in FIG. 4. In the case that a post operation of the user is received, the first multimedia resource is associated with the second multimedia resource, and the like operation is set as a trigger condition for allowing displaying the second multimedia resource.

According to the above embodiments, the predetermined interaction operation type at least includes one of: the like operation, the share operation, the comment operation, the add-to-favorites operation, or the virtual item present operation. That is, in some embodiments, the user establishes associations with different multimedia resources with respect to different predetermined interaction operation types in setting the associated multimedia resource. That is, associating the first multimedia resource with the second multimedia resource provided by the target user account includes: associating the first multimedia resource with different second multimedia resources with respect to different predetermined interaction operation types. In some embodiments, during setting the predetermined interaction operation type, the predetermined interaction operation type is set in response to an operation type configuration instruction of the target user account. The first multimedia resource is associated with different second multimedia resources based on different predetermined interaction operation types, such that the different second multimedia resources are displayed in response to different types of interaction operations of the user in displaying the first multimedia resource, and diversified trigger conditions are provided.

In some embodiments, the first multimedia resource and the plurality of second multimedia resources are subject to a predetermined or user-defined display order. Therefore, the associations are established by generating the display permission information. That is, associating the first multimedia resource with the second multimedia resource provided by the target user account includes: generating, based on the display order of the first multimedia resource and the plurality of second multimedia resources, display permission information including the display order, wherein the display permission information at least includes resource indication information of the associated multimedia resource allowed to be displayed, so as to establish an association between the first multimedia resource and the second multimedia resource. By generating the display permission information, associations between the first multimedia resource and the plurality of second multimedia resources both in terms of display and in terms of display order are established. In this way, during displaying the first multimedia resource to the user, the plurality of second multimedia resources are successively displayed in accordance with the display order in the display permission information in the case that the interaction operation initiated by the target user account satisfies the predetermined interaction operation type. As a result, the multimedia resources are automatically and initiatively displayed, and thus the man-machine interaction efficiency is improved.

In some embodiments, the first multimedia resource and the second multimedia resource in the above embodiments are two types of multimedia resources that are provided by the user. In some other embodiments, the first multimedia resource and the second multimedia resource are acquired by partitioning the same multimedia resource. The partitioning is performed prior to the setting of the resources. That is, the method further includes: acquiring partitioning information with respect to the multimedia resource, and partitioning the multimedia resource into the first multimedia resource and the second multimedia resource based on the partitioning information. The partitioning information is provided by the server, or carried in a partitioning configuration instruction triggered by the user.

Taking the partitioning information being provided by the server as an example, the server smartly generates the partitioning information for the multimedia resource. For example, upon receiving a multimedia resource, the server analyzes video content of the multimedia resource to generate partitioning information including a plurality of recommended partitioning points, such that the terminal automatically partitions the multimedia resource based on the partitioning information to acquire a plurality of segments of the same work. That is, the first multimedia resource and at least one second multimedia resources are acquired. Where the multimedia resource is large, the server provides a partitioning suggestion, which improves a partitioning efficiency of the multimedia resource.

In some embodiments, the user initiates the partitioning in response to the partitioning configuration instruction. The partitioning configuration instruction carries the partitioning information. The terminal automatically partitions the multimedia resource based on the partitioning information, and then posts the multimedia resource based on a plurality of segments acquired by partitioning. In this way, the multimedia resources acquired by partitioning are more adaptive to the actual needs of the user.

In some embodiments, whether to give a suggestion on partitioning the multimedia resource to the user is determined based on a duration of the multimedia resource. For example, in response to detecting that the duration of the multimedia resource exceeds a target duration, the terminal provides, on the resource posting interface, prompt information for recommending the user to partition the multimedia resource, and guides the user to establish associations and post the resources based on the plurality of multimedia resources acquired by partitioning.

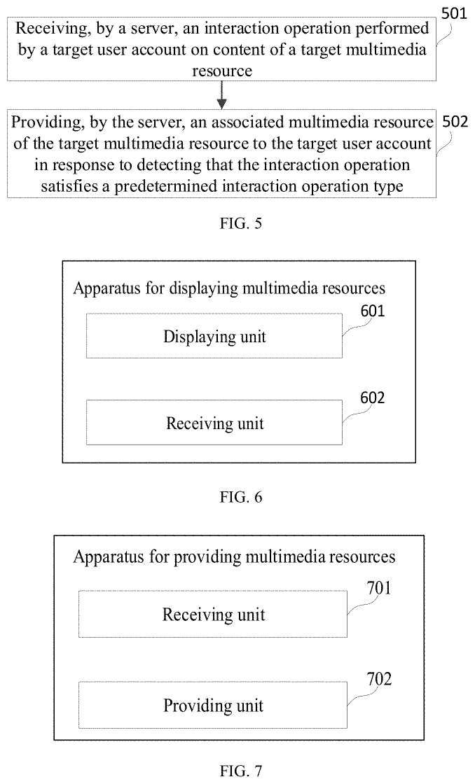

FIG. 5 is a flowchart of a method for providing multimedia resources according to an embodiment of the present disclosure. As illustrated in FIG. 5, the method is applicable to a server, and includes the following steps.

In 501, the server receives an interaction operation performed by a target user account on content of a target multimedia resource.

501 is a possible practice for the server to receive the interaction operation performed by the target user account on the target multimedia resource.

The interaction operation is initiated by the target user account on a terminal, and sent by the terminal to the server based on communication between the terminal and the server.

In 502, the server provides an associated multimedia resource of the target multimedia resource to the target user account in response to detecting that the interaction operation satisfies a predetermined interaction operation type.

502 is a possible practice for the server to provide the associated multimedia resource of the target multimedia resource to the target user account in response to the interaction operation satisfying the predetermined interaction operation type.

The server detects and determines, based on the interaction operation from the terminal, whether the interaction operation satisfies the predetermined interaction operation type, and provides and displays the associated multimedia resource of the target multimedia resource to the target user account. Determining the interaction operation type by the server is similar to determining whether the interaction operation satisfies the predetermined interaction operation type by the terminal in the above embodiments, which is not described herein any further.

In some embodiments, in response to detecting that the interaction operation type satisfies the predetermined interaction operation type, the terminal triggers, based on the communication between the terminal and the server, the server to provide the associated multimedia resource to the target user account.

In some embodiments, the predetermined interaction operation type at least includes one of: a like operation, a share operation, a comment operation, an add-to-favorites operation, or a virtual item present operation. It should be noted that the predetermined interaction operation type at least including one of the like operation, the share operation, the comment operation, the add-to-favorites operation, or the virtual item present operation means that the predetermined interaction operation type includes any one of the like operation, the share operation, the comment operation, the add-to-favorites operation, or the virtual item present operation, or the predetermined interaction operation type includes a combination of at least two of the like operation, the share operation, the comment operation, the add-to-favorites operation, or the virtual item present operation, which is not limited in the embodiments of the present disclosure.

Providing the associated multimedia resource of the target multimedia resource to the target user account in response to detecting that the interaction operation satisfies the predetermined interaction operation type includes: determining display permission information of the target user account based on the interaction operation in response to detecting that the interaction operation satisfies the predetermined interaction operation type, wherein the display permission information at least includes resource indication information of the associated multimedia resource allowed to be displayed to the target user account; and providing the associated multimedia resource indicated by the resource indication information to the target user account based on the display permission information. The above process is similar to the process performed at the side of the terminal. Based on different display permission information, the associated multimedia resource allowed to be displayed is provided to the target user account, such that diversified display fashions are provided. The process of providing the associated multimedia resource is performed based on a download request for the associated multimedia resource from the terminal, or based on the associated multimedia resource is directly pushed to the target user account based on the interaction operation, which is not specifically limited in the present disclosure.

In some embodiments, the resource indication information is indicative of a plurality of associated multimedia resources, and the display permission information further includes a display order of the plurality of associated multimedia resources; and providing the corresponding associated multimedia resource to the target user account based on the display permission information includes: acquiring the plurality of associated multimedia resources indicated by the resource indication information based on the resource indication information; and successively displaying the plurality of associated multimedia resources to the target user account based on the display order.

In some embodiments, the predetermined interaction operation type includes a comment operation for posting predetermined commentary content; and the server analyzes the commentary content to determine whether the commentary content is the predetermined commentary content. The method further includes: acquiring, by the server, in response to detecting that the interaction operation on the terminal is the comment operation, the commentary content posted by the comment operation; determining whether the commentary content is the predetermined commentary content by analyzing the commentary content; and determining, in response to the commentary content being the predetermined commentary content, that the interaction operation satisfies the predetermined interaction operation type. That is, the server acquires the commentary content posted by the comment operation in the case that the interaction operation is the comment operation; and determines that interaction operation satisfies the predetermined interaction operation type in the case that the commentary content is the predetermined commentary content.

In some embodiments, the predetermined commentary content is a comment including a predetermined keyword; and determining whether the commentary content is the predetermined commentary content by analyzing the commentary content includes: acquiring a commentary word set by word segmentation on the commentary content; and determining, in response to detecting that the commentary word set includes the predetermined keyword, that the commentary content is the predetermined commentary content.

In some embodiments, the predetermined commentary content is positive commentary content; and determining whether the commentary content is the predetermined commentary content by analyzing the commentary content includes: identifying the commentary content using a pre-trained comment identification model, and determining whether the commentary content is the positive commentary content, wherein the comment identification model is acquired by training using a predetermined machine learning algorithm based on an acquired comment sample and a predetermined positive comment verification sample, and is configured to identify input commentary content and output an identification result indicating whether the commentary content is the positive commentary content. That is, the commentary content is identified using the comment identification model; and whether the commentary content is the positive commentary content is determined.

In the above process, upon receiving the interaction operation, the terminal does not detect the interaction operation, but transfer the detection of the interaction operation to the server. Then, the server provides the associated multimedia resource based on a detection result, such that a processing load of the terminal is greatly reduced and a processing speed is increased while improving an audiovisual experience.

For the server, the resource association is established based on the operation by the target user account on the terminal, such that when a multimedia resource associated with the target user account is displayed by other user accounts, the associated multimedia resource is displayed based on the pre-established association. That is, the method further includes: associating, in response to a resource associate operation performed by the target user account on a resource association configuration interface, a first multimedia resource with a second multimedia resource that are provided by the target user account, such that in the case that the first multimedia resource is displayed, the second multimedia resource is provided in response to an interaction operation of another user account satisfying the predetermined interaction operation type.

In some embodiments, the server establishes associations between the first multimedia resource with different second multimedia resources based on the predetermined interaction operation type set by the user on the terminal. That is, the predetermined interaction operation type at least includes one of: the like operation, the share operation, the comment operation, the add-to-favorites operation, and the virtual item present operation; and associating the first multimedia resource with the second multimedia resource that are provided by the target user account includes: associating the first multimedia resource with different second multimedia resources with respect to different predetermined interaction operation types.

In some embodiments, the server receives an association instruction from the terminal. The association instruction carries resource information of the first multimedia resource, resource information of the second multimedia resource, and a predetermined interaction operation type. In response to the association instruction, the server may generate the display permission information of the first multimedia resource based on the predetermined interaction operation type to associate the first multimedia resource with the second multimedia resource, such that display of the second multimedia resource is triggered based on the display permission information in the case that an interaction operation satisfying the predetermined interaction operation type is detected.

In some embodiments, the server associates a plurality of multimedia resources based on a display order of the plurality of multimedia resources to be associated. That is, associating the first multimedia resource with the second multimedia resource that are provided by the target user account includes: generating, based on the display order of the first multimedia resource and the plurality of second multimedia resources, the display permission information including the display order, wherein the display permission information at least includes resource indication information of the associated multimedia resource allowed to be displayed, so as to establish the association between the first multimedia resource and the second multimedia resource. The user, as the poster, sets the above display order according to his or her actual needs, and during association establishment, sends the association instruction carrying the display order to the server by the terminal which the user logs in to. The server generates the display permission information including the display order in response to the association instruction, such that the display of the second multimedia resources in a specific display order is triggered based on the display permission information in the case that the interaction operation satisfying the predetermined interaction operation type is detected.

It should be noted that in providing the associated multimedia resource of the target multimedia resource, the server directly pushes the associated multimedia resource based on the interaction operation, or the terminal downloads the associated multimedia resource from the server based on the resource indication information provided by the server. For example, the terminal sends a download request to the server, wherein the download request is defined to request download of the associated multimedia resource indicated by the resource indication information; and the server returns, in response to the download request, the associated multimedia resource to the terminal for display, which is not limited in the specific embodiments of the present disclosure.

In some embodiments, with respect to the resource indication information, the opportunity for the terminal to acquire the resource indication information differs depending on configuration on the server. For example, the server carries the resource indication information in a play data stream of the target multimedia resource, and the terminal may extract the resource indication information when the play data stream of the target multimedia resource is acquired. In the case that the server independently sends the resource indication information, the terminal requests the resource indication information from the server in displaying the target multimedia resource. For details about acquisition of the resource indication information, reference may be made to the description of the above embodiments, which are not described herein any further.

FIG. 6 is a block diagram of an apparatus for displaying multimedia resources according to an embodiment of the present disclosure. As illustrated in FIG. 6, the apparatus includes: a displaying unit 601 and a receiving unit 602.

The displaying unit 601 is configured to display a target multimedia resource to a target user account.

The receiving unit 602 is configured to receive an interaction operation performed by the target user account on content of the target multimedia resource. That is, the receiving unit 602 is configured to receive the interaction operation performed by the target user account on the target multimedia resource.

The displaying unit 601 is further configured to acquire and display an associated multimedia resource of the target multimedia resource in response to detecting that the interaction operation satisfies a predetermined interaction operation type. That is, the displaying unit 601 is further configured to display the associated multimedia resource of the target multimedia resource in response to the interaction operation satisfying the predetermined interaction operation type.

In some embodiments, the predetermined interaction operation type at least includes one of: a like operation, a share operation, a comment operation, an add-to-favorites operation, and a virtual item present operation; and the displaying unit includes: a permission information determining subunit, configured to determine display permission information of the target user account based on the interaction operation in response to the interaction operation satisfying the predetermined interaction operation type, wherein the display permission information at least includes resource indication information of the associated multimedia resource allowed to be displayed to the target user account; and a first displaying subunit, configured to display the associated multimedia resource based on the display permission information.

In some embodiments, the resource indication information is indicative of a plurality of associated multimedia resources, and the display permission information further includes a display order of the plurality of associated multimedia resources; and the displaying unit includes: a resource acquiring subunit, configured to acquire the plurality of associated multimedia resources based on the resource indication information; and a second displaying subunit, configured to successively display the plurality of associated multimedia resources based on the display order.

In some embodiments, the predetermined interaction operation type includes a comment operation for posting predetermined commentary content; and the apparatus further includes: a commentary content acquiring unit, configured to acquire, in response to the interaction operation being the comment operation, commentary content posted by the comment operation; a content analyzing unit, configured to determine whether the commentary content is the predetermined commentary content by analyzing the commentary content; and a type determining unit, configured to determine, in response to the commentary content being the predetermined commentary content, that the interaction operation satisfies the predetermined interaction operation type.

In some embodiments, the predetermined commentary content is a comment including a predetermined keyword; and the content analyzing unit is configured to: acquire a commentary word set by word segmentation on the commentary content; and determine, in response to the commentary word set including the predetermined keyword, that the commentary content is the predetermined commentary content.

In some embodiments, the predetermined commentary content is positive commentary content; and the content analyzing unit is configured to: identify the commentary content using a pre-trained comment identification model; and determine whether the commentary content is the positive commentary content, wherein the comment identification model is acquired by training using a predetermined machine learning algorithm based on an acquired comment sample and a predetermined positive comment verification sample, and is configured to identify input commentary content and output an identification result indicating whether the commentary content is the positive commentary content. That is, the content analyzing unit is configured to identify the commentary content using the comment identification model, and determine whether the commentary content is the positive commentary content.

In some embodiments, the associated multimedia resource at least includes one of: other work segments of a work to which the target multimedia resource belongs, a sequel to the target multimedia resource, behind-the-scenes clips of the target multimedia resource, a customized work provided by a poster of the target multimedia resource, and a latest work of the poster of the target multimedia resource.

In some embodiments, the displaying unit includes: a prompt displaying subunit, configured to display prompt information, wherein the prompt information is defined to prompt a user to issue an instruction to display the associated multimedia resource through jumping; and

a third displaying subunit, configured to acquire and display the associated multimedia resource of the target multimedia resource in response to the instruction. That is, the third displaying subunit is configured to display the associated multimedia resource of the target multimedia resource in response to the instruction.

In some embodiments, the apparatus further includes: an association establishing unit, configured to associate, in response to a resource associate operation performed by the target user account on a resource association configuration interface, a first multimedia resource with a second multimedia resource that are provided by the target user account, such that in the case that the first multimedia resource is displayed, the second multimedia resource is displayed in response to an interaction operation of another user account satisfying the predetermined interaction operation type.

In some embodiments, the predetermined interaction operation type at least includes one of: a like operation, a share operation, a comment operation, an add-to-favorites operation, and a virtual item present operation; and the association establishing unit is configured to, with respect to different predetermined interaction operation types, associate the first multimedia resource with different second multimedia resources.

In some embodiments, the association establishing unit is configured to generate, based on a display order of the first multimedia resource and the plurality of second multimedia resources, display permission information including the display order, wherein the display permission information at least includes resource indication information of the associated multimedia resource which is allowed to be displayed, so as to establish an association between the first multimedia resource and the second multimedia resource.

In some embodiments, the apparatus includes: a partitioning unit, configured to acquire partitioning information with respect to the multimedia resource, and partition the multimedia resources into the first multimedia resource and the second multimedia resource based on the partitioning information.

FIG. 7 is a block diagram of an apparatus for providing multimedia resources according to an embodiment of the present disclosure. As illustrated in FIG. 7, the apparatus includes: a receiving unit 701 and a providing (displaying) unit 702.

The receiving unit 701 is configured to receive an interaction operation performed by a target user account on content of a target multimedia resource. That is, the receiving unit 701 is configured to receive the interaction operation performed by the target user account on the target multimedia resource.

The displaying unit 702 is configured to provide an associated multimedia resource of the target multimedia resource to the target user account in response to detecting that the interaction operation satisfies a predetermined interaction operation type. That is, the displaying unit 702 is configured to provide the associated multimedia resource of the target multimedia resource to the target user account in response to the interaction operation satisfying the predetermined interaction operation type.

In some embodiments, the predetermined interaction operation type at least includes one of: a like operation, a share operation, a comment operation, an add-to-favorites operation, and a virtual item present operation; and the providing unit includes: a permission determining subunit, configured to determine display permission information of the target user account based on the interaction operation in response to the interaction operation satisfying the predetermined interaction operation type, wherein the display permission information at least includes resource indication information of the associated multimedia resource allowed to be displayed to the target user account; and a providing subunit, configured to provide the associated multimedia resource to the target user account based on the display permission information.

In some embodiments, the resource indication information is indicative of a plurality of associated multimedia resources, and the display permission information further includes a display order of the plurality of associated multimedia resources; and the providing subunit is configured to: acquire the plurality of associated multimedia resources based on the resource indication information; and successively providing the plurality of associated multimedia resources to the target user account based on the display order.

In some embodiments, the predetermined interaction operation type includes a comment operation for posting predetermined commentary content; and the apparatus further includes: a content acquiring unit, configured to acquire, in response to the interaction operation being the comment operation, commentary content posted by the comment operation; a content analyzing unit, configured to determine whether the commentary content is predetermined commentary content by analyzing the commentary content; and a type determining unit, configured to determine, in response to the commentary content being the predetermined commentary content, that the interaction operation satisfies the predetermined interaction operation type.

In some embodiments, the predetermined commentary content is a comment including a predetermined keyword; and the content analyzing unit is configured to: acquire a commentary word set by word segmentation on the commentary content; and determine, in response to the commentary word set including the predetermined keyword, that the commentary content is the predetermined commentary content.

In some embodiments, the predetermined commentary content is positive commentary content; and the content analyzing unit is configured to: identify the commentary content using a pre-trained comment identification model; and determine whether the commentary content is the positive commentary content, wherein the comment identification model is acquired by training using a predetermined machine learning algorithm based on an acquired comment sample and a predetermined positive comment verification sample, and is configured to identify input commentary content and output an identification result indicating whether the commentary content is the positive commentary content. That is, the content analyzing unit is configured to: identify the commentary content using the comment identification model; and determine whether the commentary content is the positive commentary content.

In some embodiments, the associated multimedia resource at least includes one of: other work segments of a work to which the target multimedia resource belongs, a sequel to the target multimedia resource, behind-the-scenes clips of the target multimedia resource, a customized work provided by a poster of the target multimedia resource, and a latest work of the poster of the target multimedia resource.

In some embodiments, the apparatus further includes: an association establishing unit, configured to associate, in response to a resource associate operation performed by the target user account on a resource association configuration interface, a first multimedia resource with a second multimedia resource that are provided by the target user account, such that in the case that the first multimedia resource is displayed, the second multimedia resource is provided in response to an interaction operation of another user account satisfying the predetermined interaction operation type.

In some embodiments, the predetermined interaction operation type at least includes one of: a like operation, a share operation, a comment operation, an add-to-favorites operation, and a virtual item present operation; and the association establishing unit is configured to, with respect to different predetermined interaction operation types, associate the first multimedia resource with different second multimedia resources.

In some embodiments, the association establishing unit is configured to generate, based on a display order of the first multimedia resource and the plurality of second multimedia resources, display permission information including the display order, wherein the display permission information at least includes resource indication information of the associated multimedia resource which is allowed to be displayed, so as to establish an association between the first multimedia resource and the second multimedia resource.

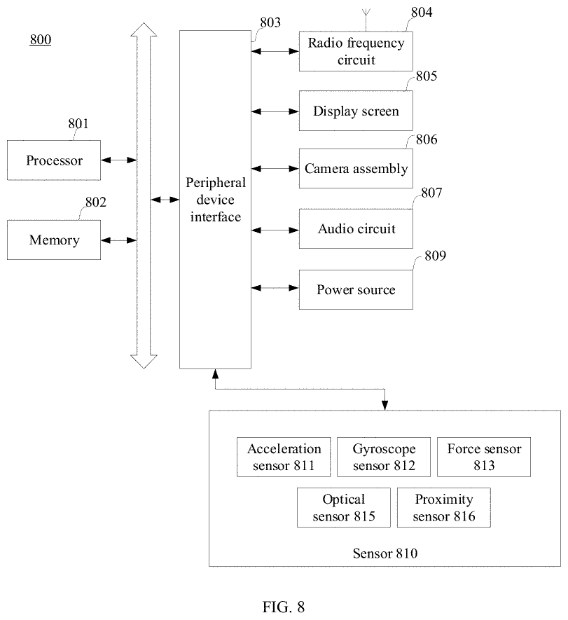

FIG. 8 is a schematic structural diagram of a terminal 800 according to an embodiment of the present disclosure. The terminal 800 may be a smart phone, a tablet computer, a Moving Picture Experts Group Audio Layer III (MP3) player, a Moving Picture Experts Group Audio Layer IV (MP4) player, a laptop computer, or a desktop computer. The terminal 800 may also be referred to as a user equipment, a portable terminal, a laptop terminal, a desktop terminal, or the like.

Generally, the terminal 800 may include one or more processors 801 and one or more memories 802.

The processor 801 may include one or more processing cores, for example, a four-core processor, an eight-core processor, or the like. The processor 801 may be implemented by at least one hardware of a digital signal processor (DSP), a field-programmable gate array (FPGA), and a programmable logic array (PLA). In some embodiments, the processor 801 may further include a primary processor and a secondary processor. The primary processor is a processor configured to process data in an active state, and is also referred to as a central processing unit (CPU). The secondary processor is a low-power consumption processor configured to process data in a standby state. In some embodiments, the processor 801 may be integrated with a graphics processing unit (GPU), wherein the GPU is configured to render and draw the content to be displayed on the display screen. In some embodiments, the processor 801 may further include an Artificial Intelligence (AI) processor configured to perform calculation operations related to machine learning.

The memory 802 may include one or more computer-readable storage media. The computer-readable storage medium may be non-transitory. The memory 802 may further include a high-speed random-access memory, and a non-volatile memory, for example, one or more magnetic disk storage devices or flash storage devices. In some embodiments, the non-transitory computer-readable storage medium in the memory 802 may be configured to store at least one instruction, wherein the at least one instruction is executed by the processor 801 to perform the method for displaying multimedia resources according to the embodiments of the present disclosure.

In some embodiments, the terminal 800 may optionally include a peripheral device interface 803 and at least one peripheral device. The processor 801, the memory 802, and the peripheral device interface 803 may be connected to each other via a bus or a signal line. The at least one peripheral device may be connected to the peripheral device interface 803 via a bus, a signal line, or a circuit board. Specifically, the peripheral device may include at least one of a radio frequency circuit 804, a display screen 805, a camera assembly 806, an audio circuit 807, or a power source 809.

The peripheral device interface 803 may be configured to connect the at least one peripheral device related to input/output (I/O) to the processor 801 and the memory 802. In some embodiments, the processor 801, the memory 802, and the peripheral device interface 803 may be integrated on the same chip or circuit board. In some other embodiments, any one or two of the processor 801, the memory 802, and the peripheral device interface 803 may be practiced on a separate chip or circuit board, which is not limited in the embodiments of the present disclosure.

The radio frequency circuit 804 may be configured to receive and transmit a radio frequency (RF) signal, which is also referred to as an electromagnetic signal. The radio frequency circuit 804 may be communicated with a communication network or another communication device via the electromagnetic signal. The radio frequency circuit 804 may convert an electrical signal to an electromagnetic signal and send the signal, or convert a received electromagnetic signal to an electrical signal. In some embodiments, the radio frequency circuit 804 may include: an antenna system, an RF transceiver, one or a plurality of amplifiers, a tuner, an oscillator, a digital signal processor, a codec chip set, a subscriber identification module card, or the like. The radio frequency circuit 804 may be communicated with another terminal based on a wireless communication protocol. The wireless communication protocol may include, but is not limited to: a metropolitan area network, various generations of mobile communication networks (including 2G, 3G, 4G, and 5G), a wireless local area network, and/or a wireless fidelity (Wi-Fi) network. In some embodiments, the radio frequency circuit 804 may further include a near-field communication (NFC)-related circuits, which is not limited in the present disclosure.

The display screen 805 may be configured to display a user interface (UI). The UE may include graphics, texts, icons, videos, and any combination thereof. In the case that the display screen 805 is a touch display screen, the display screen 805 may further have the capability of acquiring a touch signal on or above the surface of the display screen 805. The touch signal may be input to the processor 801 as a control signal for processing. In this case, the display screen 805 may be further configured to provide a virtual button and/or a virtual keyboard or keypad, also referred to as a soft button and/or a soft keyboard or keypad. In some embodiments, one display screen 805 may be provided, which is disposed on a front panel of the terminal 800. In some other embodiments, at least two display screens 805 may be provided, which are respectively disposed on different surfaces of the terminal 800 or designed in a folded fashion. In still some other embodiments, the display screen 805 may be a flexible display screen disposed on a bent surface or a folded surface of the terminal 800. Even, the display screen 805 may be further disposed as an irregular pattern other than a rectangular, that is, a specially-shaped screen. The display screen 805 may be fabricated from such materials as a liquid crystal display (LCD), an organic light-emitting diode (OLED), or the like.

The camera assembly 806 may be configured to capture an image or a video. In some embodiments, the camera assembly 806 may include a front camera and/or a rear camera. Generally, the front camera may be disposed on a front panel of the terminal, and the rear camera is disposed on a rear panel of the terminal. In some embodiments, at least two rear cameras may be disposed, which are respectively any one of a primary camera, a depth of field (DOF) camera, a wide-angle camera, and a long-focus camera, such that the primary camera and the DOF camera are fused to implement the background virtualization function, and the primary camera and the wide-angle camera are fused to implement the panorama photographing and virtual reality (VR) photographing functions or other fused photographing functions. In some embodiments, the camera assembly 806 may further include a flash. The flash may be a single-color temperature flash or a double-color temperature flash. The double-color temperature flash refers to a combination of a warm-light flash and a cold-light flash, which may be used for light compensation under different color temperatures.

The audio circuit 807 may include a microphone and a speaker. The microphone may be configured to capture an acoustic wave of a user and an environment, and convert the acoustic wave to an electrical signal and output the electrical signal to the processor 801 for further processing, or output to the radio frequency circuit 804 to implement voice communication. For the purpose of stereo capture or noise reduction, a plurality of such microphones may be provided, which are respectively disposed at different positions of the terminal 800. In some embodiments, the microphone may be a microphone array or an omnidirectional capturing microphone. The speaker may be configured to convert an electrical signal from the processor 801 or the radio frequency circuit 804 to an acoustic wave. The speaker may be a traditional thin-film speaker, or may be a piezoelectric ceramic speaker. When the speaker is a piezoelectric ceramic speaker, an electrical signal may be converted to an acoustic wave audible by human beings, or an acoustic wave inaudible by human beings for the purpose of ranging or the like. In some embodiments, the audio circuit 807 may further include a headphone plug.

The power source 809 may be configured to supply power for various components in the terminal 800. The power source 809 may be an alternating current, a direct current, a disposable battery, or a rechargeable battery. In the case that the power source 809 includes a rechargeable battery, the rechargeable battery may support wired charging or wireless charging. The rechargeable battery may also support the supercharging technology.

In some embodiments, the terminal 800 may further include one or more sensors 810. The one or more sensors 810 may include, but are not limited to: an acceleration sensor 811, a gyroscope sensor 812, a force sensor 813, an optical sensor 815, and a proximity sensor 816.

The acceleration sensor 811 may be configured to detect accelerations on three coordinate axes in a coordinate system established for the terminal 800. For example, the acceleration sensor 811 may be configured to detect components of a gravity acceleration on the three coordinate axes. The processor 801 may control the display screen 805 to display the user interface in a horizontal view or a longitudinal view based on a gravity acceleration signal acquired by the acceleration sensor 811. The acceleration sensor 811 may be further configured to acquire motion data of a game or a user.

The gyroscope sensor 812 may be configured to detect a body direction and a rotation angle of the terminal 800, and the gyroscope sensor 812 may be collaborated with the acceleration sensor 811 to capture a 3D action performed by the user for the terminal 800. Based on the data acquired by the gyroscope sensor 812, the processor 801 may implement the following functions: action sensing (for example, modifying the UI based on an inclination operation of the user), image stabilization in photographing, game control, and inertial navigation.

The force sensor 813 may be disposed on a side frame of the terminal 800 and/or on a lowermost layer of the display screen 805. In the case that the force sensor 813 is disposed on the side frame of the terminal 800, a grip signal of the user against the terminal 800 may be detected, and the processor 801 may perform a left or right hand identification or perform a shortcut operation based on the grip signal acquired by the force sensor 813. In the case that the force sensor 813 is disposed on the lowermost layer of the display screen 805, the processor 801 may implement control of an operable control on the UI based on a force operation of the user against the display screen 805. The operable control may include at least one of a button control, a scroll bar control, an icon control, and a menu control.

The optical sensor 815 may be configured to acquire the intensity of ambient light. In one embodiment, the processor 801 may control a display luminance of the display screen 805 based on the intensity of ambient light acquired by the optical sensor 815. Specifically, when the intensity of ambient light is high, the display luminance of the display screen 805 may be up-shifted; and when the intensity of ambient light is low, the display luminance of the display screen 805 may be down-shifted. In another embodiment, the processor 801 may further dynamically adjust photographing parameters of the camera assembly 806 based on the intensity of ambient light acquired by the optical sensor 815.

The proximity sensor 816, also referred to as a distance sensor, may be generally disposed on the front panel of the terminal 800. The proximity sensor 816 may be configured to acquire a distance between the user and the front face of the terminal 800. In one embodiment, when the proximity sensor 816 detects that the distance between the user and the front face of the terminal 800 gradually decreases, the processor 801 may control the display screen 805 to switch from an active state to a rest state; and when the proximity sensor 816 detects that the distance between the user and the front face of the terminal 800 gradually increases, the processor 801 may control the display screen 805 to switch from the rest state to the active state.

A person skilled in the art may understand that the structure of the terminal as illustrated in FIG. 8 does not construe a limitation on the terminal 800. The terminal 800 may include more or fewer components over those illustrated in FIG. 8, or combinations of some components, or employ different component deployments.

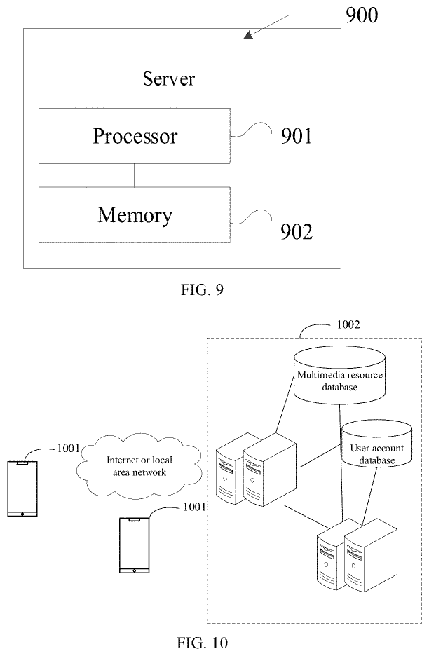

FIG. 9 is a block diagram of a server 900 according to an embodiment of the present disclosure. The server 900 may greatly vary due to different configurations or performances, and may include one or more central processing units (CPUs) 901 and one or more memories 902. The memory 902 stores one or more instructions, wherein the one or more instructions, when loaded and executed by the processor 901, cause the processor 901 to perform the method for providing the multimedia resources according to the method embodiments. Nevertheless, the server may further include such components as a wired or wireless network interface, a keyboard, an input/output interface, and the like for inputs and outputs; and the server may further include other components configured to implement device functions, which is not described herein any further.

An embodiment further provides a computer-readable storage medium storing one or more instructions, for example, a memory including one or more instructions. The one or more instructions, when loaded and executed by a processor of an electronic device, cause the electronic device to perform the method for displaying the multimedia resources and the method for providing the multimedia resources according to the above embodiments. The electronic device includes a terminal or a server. In some embodiments, the computer-readable storage medium may be a non-transitory computer-readable storage medium. For example, the non-transitory computer-readable storage medium may be a read-only memory (ROM), a random-access memory (RAM), a compact disc ROM (CD-ROM), a magnetic tape, a floppy disk, an optical data storage device, or the like.

An embodiment of the present disclosure further provides a computer program product including one or more executable instructions. The one or more executable instructions, when loaded and executed by a processor of an electronic device, cause the electronic device to perform the method for displaying the multimedia resources and the method for providing the multimedia resources according to the above embodiments. The electronic device includes a terminal or a server.

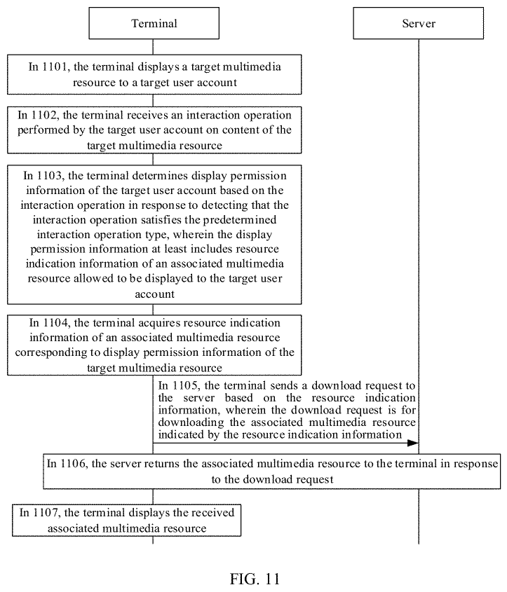

FIG. 10 is an architecture diagram of a system 100 for displaying multimedia resources according to an embodiment of the present disclosure. Referring to FIG. 10, the system 100 for displaying the multimedia resources includes: a terminal 1001 and a server 1002.

The terminal 1001 is connected to the server 1002 via a wireless network or a wired network. The terminal 1001 is configured to perform the operations in the method for displaying the multimedia resources at the side of the terminal. The terminal 1001 may be at least one of a smart phone, a game console, a desktop computer, a tablet computer, an electronic book reader, a Moving Picture Experts Group Audio Layer III (MP3) player, a Moving Picture Experts Group Audio Layer IV (MP4) player, and a laptop computer. A client supporting display of the multimedia resource is installed and runs on the terminal 1001. The application client is a multimedia resource client, a social media client, an instant messaging client, or the like. Exemplarily, the terminal 1001 is a terminal used by the user, and the client running on the terminal 1001 is logged in to by a user account.

The server 1002 is configured to perform the operations in the method for providing the multimedia resources at the side of the server as described above to provide the associated multimedia resource to the terminal. In some embodiments, the server 1002 includes: an access server, a multimedia resource server, and a database. The access server is configured to provide an access server for the terminal 1001. The multimedia resource server is configured to provide a back-end service related to the multimedia resource. The database includes a multimedia resource database, a user account database, and the like. Nevertheless, the database further includes, for example, a user behavior database. Different databases correspond to different services provided by the server. One or more multimedia resource servers are provided. In the case that a plurality of multimedia resource servers are provided, at least two of the multimedia resource servers are configured to provide different services, and/or at least two of the multimedia resource servers are configured to provide the same service, for example, providing the same service in a load-balancing fashion, which is not limited in the embodiments of the present disclosure.

The terminal 1001 may generally refer to one of a plurality of terminals. This embodiment is described by taking the terminal 1001 as an example.

A person skilled in the art may appreciate that the number of terminals may be larger or smaller. For example, the number of terminals may be only one, tens or hundreds, or even more; and in this case, other terminals may also be involved in the above implementation environment. The number of terminals and the type of devices are not limited in the embodiments of the present disclosure.

Hereinafter, based on the system architecture as illustrated in FIG. 10, description is given using scenario of displaying multimedia resources based on the system for displaying the multimedia resources as an example. FIG. 11 is an interaction flowchart of a method for displaying multimedia resources according to an embodiment of the present disclosure. Referring to FIG. 11, the method for displaying multimedia resources includes the following content.

In 1101, a terminal displays a target multimedia resource to a target user account.

In the embodiments of the present disclosure, the terminal downloads the target multimedia resource from a server in response to a play operation performed by the target user account logging in to the terminal on the target multimedia resource, such that the downloaded target multimedia resource is displayed.

In 1102, the terminal receives an interaction operation performed by the target user account on content of the target multimedia resource.

1102 is similar to 102 and 202 in the above embodiments, which is not described herein any further.

In 1103, the terminal determines display permission information of the target user account based on the interaction operation in response to detecting that the interaction operation satisfies the predetermined interaction operation type, wherein the display permission information at least includes resource indication information of an associated multimedia resource allowed to be displayed to the target user account.

1103 is similar to 203 in the above embodiments, which is not described herein any further.

It should be noted that in the embodiments of the present disclosure, description is given using the scenario of determining whether the interaction operation performed by the terminal satisfies the predetermined interaction operation type as an example. In some embodiments, the terminal sends the interaction operation to the server, and the server detects whether the interaction operation satisfies the predetermined interaction operation type. For detail about the detection, reference may be made to the description in 502. For example, with respect to a comment operation, upon receiving commentary content, the server analyzes the commentary content to determine whether the commentary content is predetermined commentary content. In this way, the analyzing process is performed by the server, such that a processing load of the terminal is greatly reduced, and a processing speed is improved.

In 1104, the terminal acquires resource indication information of an associated multimedia resource corresponding to display permission information of the target multimedia resource.

The resource indication information is acquired by any method described in 204, which is not limited in the embodiments of the present disclosure.

In some embodiments, the terminal further displays prompt information, wherein the prompt information is defined to prompt a user to issue an instruction to display the associated multimedia resource through jumping; and acquires and displays the associated multimedia resource of the target multimedia resource in response to the instruction. By the above process, the associated multimedia resource is acquired in the case that the target user account desires to play the associated multimedia resource, such that waste of traffic is prevented.

In 1105, the terminal sends a download request to the server based on the resource indication information, wherein the download request is defined to request download of the associated multimedia resource indicated by the resource indication information.

In 1106, the server returns the associated multimedia resource to the terminal in response to the download request.

In 1107, the terminal displays the received associated multimedia resource.

It should be noted that 1104 and 1107 are interpreted as a possible practice for the terminal to acquire and display the associated multimedia resource by interactions between the terminal and the server based on the display permission information. In the above process, the server implements a function of providing the associated multimedia resource to the terminal. As described in the above examples, for displaying multimedia resources, the terminal determines, based on the triggered interaction operation, an associated multimedia which the target user account has a permission to display, and then acquires and displays the associated multimedia resource by interactions between the terminal and the server based on resource indication information of the determined associated multimedia resource. In this way, an effect of triggering display of a plurality of different multimedia resources segment by segment by the interaction operation performed on the content is achieved.

In some embodiments, based on the above system architecture, the terminal sends the triggered interaction operation to the server, and the server detects whether the interaction operation satisfies the predetermined interaction operation type. In this way, in the case that the interaction operation satisfies the predetermined interaction operation type, the server determines the display permission information and acquires the resource indication information of the associated multimedia resource, and delivers the associated multimedia resource to the terminal based on the acquired resource indication information, such that the terminal is capable of displaying the associated multimedia resource delivered by the server to achieve the effect of triggering the display of the plurality of different multimedia resources segment by segment by the interaction operation performed on the content. The embodiments of the present disclosure set no limitation on practice of the above technical solutions.

All the embodiments of the present disclosure may be independently practiced, or practiced in combination with other embodiments, which are all considered as falling within the protection scope of the present disclosure.

What is claimed is:

1. A method for displaying multimedia resources, applicable to a terminal, the method comprising:
receiving an interaction operation performed by a target user account on a target multimedia resource; and
displaying an associated multimedia resource of the target multimedia resource in response to the interaction operation satisfying a predetermined interaction operation type.

2. The method according to claim 1, wherein the predetermined interaction operation type comprises at least one of: a like operation, a share operation, a comment operation, an add-to-favorites operation, or a virtual item present operation; and
displaying the associated multimedia resource of the target multimedia resource in response to the interaction operation satisfying the predetermined interaction operation type comprises:
determining display permission information of the target user account based on the interaction operation in response to the interaction operation satisfying the predetermined interaction operation type, wherein the display permission information comprises at least resource indication information of the associated multimedia resource allowed to be displayed to the target user account; and
displaying the associated multimedia resource based on the display permission information.

3. The method according to claim 2, wherein the resource indication information is indicative of a plurality of associated multimedia resources and the display permission information further comprises a display order of the plurality of associated multimedia resources; and
displaying the associated multimedia resource based on the display permission information comprises:
acquiring the plurality of associated multimedia resources based on the resource indication information; and
successively displaying the plurality of associated multimedia resources based on the display order.

4. The method according to claim 1, wherein the predetermined interaction operation type comprises a comment operation for posting predetermined commentary content; and the method further comprises:
acquiring, in response to the interaction operation being the comment operation, commentary content posted by the comment operation; and
determining, in response to the commentary content being the predetermined commentary content, that the interaction operation satisfies the predetermined interaction operation type.

5. The method according to claim 4, wherein the predetermined commentary content is a comment comprising a predetermined keyword; and the method further comprises:
acquiring a commentary word set by word segmentation on the commentary content; and
determining, in response to the commentary word set comprising the predetermined keyword, that the commentary content is the predetermined commentary content.

6. The method according to claim 4, wherein the predetermined commentary content is positive commentary content; and the method further comprises:
identifying the commentary content using a comment identification model, and determining whether the commentary content is the positive commentary content, wherein the comment identification model is acquired by training using a predetermined machine learning algorithm based on an acquired comment sample and a predetermined positive comment verification sample, and is configured to identify input commentary content and output an identification result indicating whether the commentary content is the positive commentary content.

7. The method according to claim 1, wherein the associated multimedia resource comprises at least one of: other work segments of a work to which the target multimedia resource belongs, a sequel to the target multimedia resource, a behind-the-scenes clip relating to the target multimedia resource, a customized work provided by a poster of the target multimedia resource, and a latest work of the poster of the target multimedia resource.

8. The method according to claim 1, wherein displaying the associated multimedia resource of the target multimedia resource comprises:
displaying prompt information, wherein the prompt information is defined to prompt a user to issue an instruction to display the associated multimedia resource through jumping; and
displaying the associated multimedia resource of the target multimedia resource in response to the instruction.

9. A method for providing multimedia resources, applicable to a server, the method comprising:
receiving an interaction operation performed by a target user account on a target multimedia resource; and
providing an associated multimedia resource of the target multimedia resource to the target user account in response to the interaction operation satisfying a predetermined interaction operation type.

10. The method according to claim 9, wherein the associated multimedia resource comprises at least one of: other work segments of a work to which the target multimedia resource belongs, a sequel to the target multimedia resource, a behind-the-scenes clip relating to the target multimedia resource, a customized work provided by a poster of the target multimedia resource, and a latest work of the poster of the target multimedia resource.

11. The method according to claim 9, further comprising:
associating, in response to a resource associate operation performed by the target user account on a resource association configuration interface, a first multimedia resource with a second multimedia resource that are provided by the target user account, such that in a case that the first multimedia resource is displayed, the second multimedia resource is provided in response to an interaction operation of another user account satisfying the predetermined interaction operation type.

12. The method according to claim 11, wherein associating the first multimedia resource with the second multimedia resource provided by the target user account comprises:
associating the first multimedia resource with different second multimedia resources with respect to different predetermined interaction operation types.

13. The method according to claim 11, wherein associating the first multimedia resource with the second multimedia resource provided by the target user account comprises:
generating, based on a display order of the first multimedia resource and a plurality of second multimedia resources, display permission information comprising the display order, wherein the display permission information at least comprises resource indication information of the associated multimedia resource allowed to be displayed, to establish an association between the first multimedia resource and the second multimedia resource.

14. The method according to claim 11, further comprising:
partitioning the target multimedia resource into the first multimedia resource and the second multimedia resource based on partitioning information with respect to the target multimedia resource.

15. A terminal, comprising:
a processor; and
a memory configured to store one or more instructions executable by the processor;
wherein the processor, when loading and executing the one or more instructions, is configured to:
receive an interaction operation performed by a target user account on a target multimedia resource; and
display an associated multimedia resource of the target multimedia resource in response to the interaction operation satisfying a predetermined interaction operation type.

16. The terminal according to claim 15, wherein the predetermined interaction operation type at least comprises one of: a like operation, a share operation, a comment operation, an add-to-favorites operation, or a virtual item present operation; and
the processor, when loading and executing the one or more instructions, is configured to:
determine display permission information of the target user account based on the interaction operation in response to the interaction operation satisfying the predetermined interaction operation type, wherein the display permission information at least comprises resource indication information of the associated multimedia resource allowed to be displayed to the target user account; and
display the associated multimedia resource based on the display permission information.

17. The terminal according to claim 16, wherein the resource indication information is indicative of a plurality of associated multimedia resources, and the display permission information further comprises a display order of the plurality of associated multimedia resources; and
the processor, when loading and executing the one or more instructions, is configured to:
acquire the plurality of associated multimedia resources based on the resource indication information; and
successively display the plurality of associated multimedia resources based on the display order.

18. The terminal according to claim 15, wherein the predetermined interaction operation type comprises a comment operation for posting predetermined commentary content; and the processor, when loading and executing the one or more instructions, is configured to:
acquire, in response to the interaction operation being the comment operation, commentary content posted by the comment operation; and
determine, in response to the commentary content being the predetermined commentary content, that the interaction operation satisfies the predetermined interaction operation type.

19. The terminal according to claim 18, wherein the predetermined commentary content is a comment comprising a predetermined keyword; and the processor, when loading and executing the one or more instructions, is configured to:
acquire a commentary word set by word segmentation on the commentary content; and
determine, in response to the commentary word set comprising the predetermined keyword, that the commentary content is the predetermined commentary content.

20. The terminal according to claim 18, wherein the predetermined commentary content is positive commentary content; and the processor, when loading and executing the one or more instructions, is configured to:
identify the commentary content using a comment identification model, and determine whether the commentary content is positive commentary content, wherein the comment identification model is acquired by training using a predetermined machine learning algorithm based on an acquired comment sample and a predetermined positive comment verification sample, and is configured to identify input commentary content and output an identification result indicating whether the commentary content is positive commentary content.
